(19) United States
(12) Patent Application Publication
(10) Pub. No.: US 2021/0358711 A1
(43) Pub. Date: Nov. 18, 2021

(54) FUSE LINK COMPRISING PERMANENT MAGNET FOR INDUCING ARC DIRECTIVITY

(71) Applicant: Seung Pyo HONG, Cheongju-si (KR)

(72) Inventor: Seung Pyo HONG, Cheongju-si (KR)

(21) Appl. No.: 17/040,866

(22) PCT Filed: Jan. 3, 2019
(86) PCT No.: PCT/KR2019/000119

§ 371 Date: Sep. 23, 2020

(30) Foreign Application Priority Data
Dec. 28, 2018 (KR) 10-2018-0171669

(51) Int. Cl. H01H 85/02; H01H 85/38; H02B 1/18

(52) U.S. Cl. CPC H01H 85/0241; H01H 2085/386; H02B 1/18; H01H 85/38

(57) ABSTRACT

A fuse link including magnet for inducing arc directivity is provided, in which the magnet is arranged in an inner surface, an outer surface or the inside of an insulating tube forming the fuse link, and the progress direction of arc energy is coherently directed in a certain direction in accordance with Fleming's left-hand rule by the direction of magnetic field of the arranged magnet so as to increase a disconnection speed of an element (i.e., reducing a blocking speed of a fault current), thereby increasing fault current blocking performance of the fuse link. In particular, a position of the magnet arranged on the insulating tube is arranged at a middle point between a notched portion and the notched portion, a point of notched portion, and the insulating tube corresponding to the middle point between the notched portion and the notched portion and the point of notched portion.

### TECHNICAL FIELD

The present invention relates to a fuse link that is installed in a power distribution device or the like to block current when a fault current occurs. A fuse assembly is mounted on the power line for the purpose of protecting the load from fault currents in the event of fault current such as short circuit/ground fault/over current for AC/DC power supply. The fuse assembly includes a fuse base that houses the fuse therein and a fuse that is housed inside the fuse link. Depending on the type of these fuses, protection functions are added according to functional classifications such as short circuit protection and over current/short circuit protection. The fuse is intended to prevent fire and protect human life by disconnecting the power current by melting and blocking the element inside the fuse to protect the load from a fault current when the fault current flows in. When a fault current flows into the fuse, a current disconnection occurs due to the melting of the element inside the fuse link, and an arc occurs when the current is disconnected. In particular, it is desirable to melt the element inside the fuse in the shortest time to cause it to be broken when the fault current flows in.

The present invention is an invention to block a fuse link by melting an element inside a fuse link in the shortest time by using a permanent magnet that induces directivity to an arc generated when a current is disconnected (more specifically, when an element of a fuse link is melted).

### BACKGROUND ART

Conventionally, there is a technology for improving the working voltage of the fuse by increasing the disconnection speed of the fuse by inserting a magnet into a fuse base (an assembly that houses the fuse therein) in which the fuse is accommodated and installed therein. The prior art as described above relates to a technology for improving the working voltage of the fuse by increasing the disconnection speed of the fuse.

In the prior art, in order to improve the element disconnection performance of a fuse applied to an AC power and DC power system, a method in which the element notched portions are simultaneously melted through a method such as designing a uniform shape of the element notched portions was used. However, since the direction of the magnetic field intensity generated in the element notched portion is not determined, the magnetic field strength occurs in the discrete direction. Therefore, the direction and uniformity of the arc energy cannot be guaranteed. As a result, there is a problem that the fuse explodes when a fault current, which is a large current, occurs because the melting rate of the element notched portion is slow.

In addition, it is possible to prevent the occurrence of a recovery voltage when the notched portion is separated from the element to secure an insulation distance from which the electric current part is separated, thereby preventing the secondary inflow of a fault current. However, if the magnetic field intensity is largely introduced only to the notched portion at a specific point, simultaneous melting of the notched portion becomes impossible. When an arc occurs because melting occurs only in the notched portion at a specific point, the arc current cannot secure an insulation distance, and a electric current is formed in the molten notched portion, thereby generating a recovery voltage. Due to this, the fuse explodes due to the fault current or causes a fire, causing a fatal problem that cannot protect the circuit.

The present invention is to solve the problems of the prior art as described above.

The present invention allows the notching portion to be melted simultaneously to completely block the fault current, generates equal magnetic field intensity between the notched portions to enable simultaneous melting of the notched portion, in order to generate an equal magnetic field intensity, a magnet is placed at an equal position between at least two or more notched portions, or a magnet is placed at the top of two or more notched portions to induce uniform magnetic field intensity, and by determining the direction of the force of the same magnitude, the arc energy generated by melting of the notched portion is minimized when a fault current flows through the distribution of the same arc energy between the notched portions. By doing so, it is intended to increase the blocking speed while minimizing the amount of energy applied to the insulating tube protecting the outer wall of the fuse link.

### DISCLOSURE OF THE INVENTION

### Technical Problem

The present invention is characterized in that the direction of magnetic field of the magnet formed into the fuse link is determined such that a magnet is inserted into the fuse link, and the direction of arc generated during disconnection is a direction to increase the element disconnection speed in the fuse link.

The present invention is characterized in that the direction of magnetic field of the magnet inserted into the fuse link is determined such that a magnet is inserted into the fuse link, and the direction of arc generated during disconnection is a direction to increase the element disconnection speed in the fuse link. That is, in the present invention, a magnet (permanent magnet) that is inserted into the fuse link and induces the direction of the arc is in the fuse link and is installed between notched portions of an element designed to block a fault current or at a vertical or horizontal position of the notched portion. By doing so, it is possible to match the direction of the arc energy generated in the notched portion in a specific direction.

In addition, the present invention's object is as following. A magnet (permanent magnet) inserted into the fuse link and inducing the direction of the arc assembled in the fuse link is installed between the notched portions of the elements designed to block the fault current, or at a vertical or horizontal position of the notched portion. With the above configuration, the blocking speed is increased and the blocking time is reduced by allowing the notched part to melt at the same time, and the peak value of the arc blocking current is reduced by advancing the blocking point of the fault current according to the reduction of the blocking time, and the amount of arc energy generated when the notching portion is blocking is reduced.

### Technical Solution

In order to solve the above problems, a fuse link comprising permanent magnet for inducing arc directivity according to the present invention includes an insulating material and a housing-shaped insulating tube 100 having a space therein; an element 200 formed in the inner space of the insulating tube 100 and having at least one notched portion 210 formed therein; at least one or more magnet 600 formed in the insulating tube 100 to provide a direction of arc energy to the arc generated in the notched portion when the notched portion 210 of the element 200 is melted by inducing the magnetic field intensity of the same size to the notched portion, and at least one element 200 is formed in the inner space of the insulating tube 100.

### Advantageous Effects

According to the present invention, since the arc energy can be reduced by reducing the blocking speed of the fuse link and the blocking current of the fuse link, the size of the configuration factor of the protective fuse link of the same AC/DC voltage rating and current rating can be reduced, and thus the fuse link size can be reduced for fuse links of the same voltage/current rating. In addition, the size of the system using the fuse link can be reduced by reducing the size of the fuse link, and if there is a space limitation for using the fuse link, a fuse link with a smaller size compared to the conventional fuse link can be applied to the same current/voltage rating or higher voltage/current rating. Therefore, there is an effect that can solve the system space limitation.

In addition, since the system size using the fuse link can be reduced, the system construction cost can be reduced accordingly, and the size of the fuse link can be reduced, thereby reducing the manufacturing cost of the manufacturer of the fuse link.

In addition, the blocking speed is increased and the blocking time is reduced by allowing the notched part to melt at the same time, and the peak value of the arc blocking current is reduced by advancing the blocking point of the fault current according to the reduction of the blocking time, and the amount of arc energy generated when the notching portion is blocking is reduced.

### BRIEF DESCRIPTION OF DRAWINGS

FIG. 1 is a perspective schematic diagram of a fuse link applied to the prior art;

FIG. 2 is a perspective schematic diagram of a fuse link according to the first embodiment of the present invention;

FIG. 3 is an explanatory view showing the progress direction of arc energy according to the first embodiment of the present invention;

FIG. 4 is a perspective schematic diagram of a fuse link according to a second embodiment of the present invention;

FIG. 5 is an explanatory view showing the progress direction of arc energy according to the second embodiment of the present invention;

FIG. 6 is a perspective schematic diagram of a fuse link according to a third embodiment of the present invention;

FIG. 7 is an explanatory view showing the progress direction of arc energy according to the third embodiment of the present invention;

FIG. 8 is a perspective schematic diagram of a fuse link according to a fourth embodiment of the present invention;

FIG. 9 is an explanatory view showing the progress direction of arc energy according to the fourth embodiment of the present invention;

FIG. 10 is a perspective schematic diagram of a fuse link according to a fifth embodiment of the present invention;

FIG. 11 is an explanatory view showing the progress direction of arc energy according to the fifth embodiment of the present invention;

FIG. 12 is a perspective schematic diagram of a fuse link according to a sixth embodiment of the present invention;

FIG. 13 is an explanatory view showing the progress direction of arc energy according to the sixth embodiment of the present invention;

FIG. 14 is an exemplary view of the magnet formation position of the present invention.

### DESCRIPTION OF REFERENCE NUMBER

100: Insulating tube
200: Element
210: Notched portion
300: Cap
400: Power connection
500: Silica sand layer
600: Magnet

### MODE FOR CARRYING OUT THE INVENTION

Hereinafter, exemplary embodiments of the present invention will be described in detail with reference to the accompanying drawings.

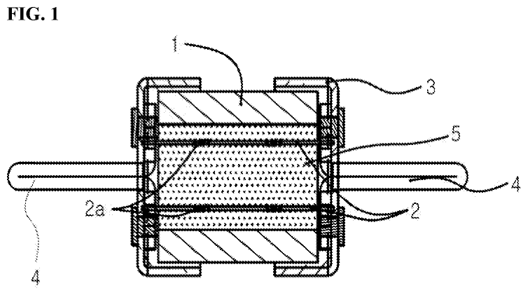

A conventional fuse link shown in FIG. 1 is mounted on a power line for the purpose of protecting a load from a fault current when the accident current such as a short circuit/ground fault/overcurrent occurs for the AC/DC power supply unit.

Such a conventional fuse link is configured to conduct current through the element 2 connected to the power connection unit 4 to which the power is connected, and at this time, the element is configured such that the element notched portion 2a is melted at a specific current, and is enclosed by a housing-shaped insulating tube 1 for insulation of the tube, and the insulating tube 1 provides a means of being blocked from the outside by a cap 3 that is assembled with a power connection unit.

When the inner of the insulating tube 1 of the fuse link and the cap 3 is filled with silica sand 5 and the element notched portion 2a is melted by energizing a limiting current of more than a specific current value exceeding the rated current, an arc voltage is generated. At this time, the element notched portion 2a is adsorbed to the separated element 2 and the element 2 connected to the power connection unit 4 and serves as an insulating material to insulate from the arc voltage. The element 2 has two or more element notched portions 2a. At this time, when a fault current exceeding a certain limit current flows in, the notched portion is melted by the heat generated in the element notched portion 2a by the current, thereby blocking the fault current. As a result, the insulation performance is increased, and the fault current generated by the recovery voltage generated after the fault current is blocked.

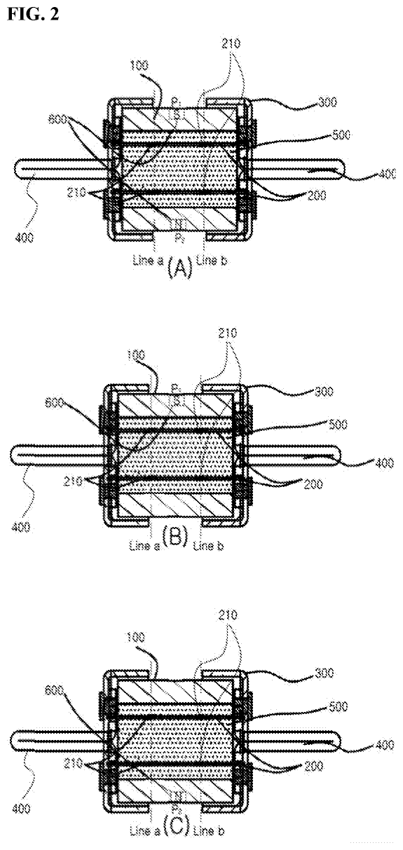

The present invention relates to a fuse link having the purpose of protecting a load from an accidental current when an accidental current occurs. As shown in FIG. 2, the present invention includes an insulating material and a housing-shaped insulating tube 100 having a space therein; an element 200 formed in the inner space of the insulating tube 100 and having at least one notched portion 210 formed therein; at least one or more magnet 600 formed in the insulating tube 100 to provide a direction of arc energy to the arc generated in the notched portion when the notched portion 210 of the element 200 is melted by inducing the magnetic field intensity of the same size to the notched portion.

In addition, the present invention may additionally include a cap 300 that surrounds the entire outer surface of the insulating tube 100 or a portion of both sides of the outer surface of the insulating tube 100.

In addition, the present invention may additionally include a power connection unit 400 formed in the cap 300.

In addition, the present invention may additionally include a silica sand layer 500 filled in the inner space of the insulating tube 100 may be configured.

The insulating tube 100 is made of an insulating material and has a structure in the form of a housing having a space therein, and an element 200 that is cut by the fault current to block the fault current is installed in the internal space.

In addition, the shape of the insulating tube 100 can be applied irrespective of the shape of a cylinder, a rectangular parallelepiped, or a regular cube.

The element 200 is a conductive material, and has at least one notched portion 210 as shown in FIG. 2. As the notched portion is melted by heat, it is cut (disconnected) to block the fault current, and an arc is generated in the notched portion along with heat at the time when the notched portion starts to melt. The magnitude of the arc energy of the arc generated at this time is proportional to the blocking time of the fault current, and is proportional to the square of the current peak value at the time of blocking of the incoming fault current.

The generated arc energy exerts a high-temperature, high-pressure impact on the inner surface of the insulating tube 100 of the fuse link.

When the tube is damaged by the impact of such arc energy, the silica sand filled in the insulating tube surrounding the element 200 in the fuse link protrudes to the outside and the insulation is destroyed. When a recovery voltage occurs, the fault current is applied again, and the fuse link does not protect the circuit to be protected, and a fire occurs or the devices to be protected in the circuit cannot be protected, causing damage to the device. This can cause serious property damage to users of the system and, in some cases, serious personal injury due to explosions of devices and components in the circuit.

Therefore, in order to minimize the problems caused by arc energy (an insulating tube breakage, device breakage, etc.), the time for generating arc energy due to a fault current must be shortened as much as possible, so the element 200 must be cut and disconnected as soon as possible. However, in a conventional fuse link, since the direction of arc energy of the arc generated when the fault current is introduced is irregular, the element is cut off after a certain period of time to form a disconnection.

For the shortest time disconnection of the element 200, in the present invention, when a fault current occurs, a magnet (permanent magnet or a magnetic substance equivalent to a permanent magnet) is inserted into the fuse link so that the direction of arc energy generated when the current is blocking by melting of the element 200 is in a certain direction. The direction of magnetic field of the magnet advances the direction of irregular arc energy in a certain direction, so that the element is cut and disconnected in the shortest time, thereby enabling a high-speed blocking operation of the fuse link.

In particular, in the present invention, when two or more elements 200 are formed, as shown in FIG. 2, the position of each notched portion 210 formed on any one element 200 is It is characterized in that it is formed so as to be located on the same line (lines a and b in FIG. 2) as each notched portion 210 formed on the different element 200.

The reason for forming the positions of the notched portions 210 respectively formed on the different elements 200 on the same line is to cause that the same magnetic field intensity reaches the notched portions 210, so that the notched portions 210 are cut at the same time, thereby occurring the disconnection. This will be described in detail in the description of the magnet 600.

In addition, in the present invention, the shape of the element 200 is characterized in that it includes a linear shape, a triangular wave shape, a pulse wave shape, or a combination of a triangle wave shape and a pulse wave shape. However, in the present invention, the shape of the element 200 is not limited to a linear shape, a triangular wave shape, a pulse wave shape, a combination of a triangle wave shape and a pulse wave shape. The shape of the element is characterized in that it includes various types of deformation capable of extending the length of the element 200 compared to the linear shape.

In the present invention, the magnet 600 is formed in the insulating tube 100 to provide the progress direction of arc energy to the arc generated in the notched portion, when the notched portion 210 of the element 200 is melted by the fault current by inducing the magnetic field intensity of the same size in the notched portion.

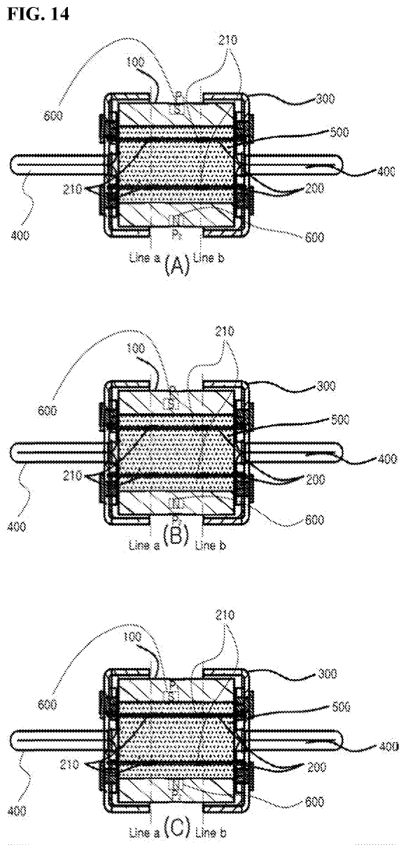

As shown in FIG. 14, the magnet 600 is inserted into the outer surface of the insulating tube 100 (FIG. 14 (A)) or inserted into the inner side of the insulating tube 100 (FIG. 14 (C)) or inserted into the inner insulating tube 100 (FIG. 14 (B)). In particular, when the magnet 600 is disposed on the outer surface of the tube 100, the magnet 600 disposed on the outer side of the insulating tube 100 and the outer side of the insulating tube 100 is coated with an insulating material so that the magnet 600 is insulated so that it does not act as a conductor.

In addition, the magnet 600 is characterized in that it is a permanent magnet having an N-pole or S-pole polarity that forms a magnetic field orthogonal to the direction of the current flowing through the element 200, or a magnetic material equivalent thereto.

In the present invention, the arrangement of the magnet 600 has six embodiments as shown in FIGS. 2, 4, 6, 8, 10, 12.

First, according to the first embodiment of the magnet arrangement of the present invention shown in FIG. 2, in the magnet 600, at least one magnet is disposed in an insulating tube at a position corresponding to a middle point between the notched portion and the notched portion (P1, P2 in FIG. 2), so that the magnetic field intensity of the same size is induced in each notched portion 210.

At least one or more magnet disposed in an insulating tube at a position (P1, P2 in FIG. 2) corresponding to a middle point between the notched portion 210 and the notched portion 210, as shown in FIG. 2(A), may be disposed in both at the insulating tube (the outer surface or the inner surface or inside of the insulating tube) of the vertical upper point of the element (P1 in FIG. 2) corresponding to the middle point between the notched portion and the notched portion and the insulating tube (the outer surface or the inner surface or inside of the insulating tube) of the vertical lower point of the element (P2 in FIG. 2) corresponding to the middle point between the notched portion and the notched portion, or as shown in FIG. 2(B), may be disposed only at the insulating tube (the outer surface or the inner surface or inside of the insulating tube) of the vertical upper point of the element (P1 in FIG. 2) corresponding to the middle point between the notched portion and the notched portion, or as shown in FIG. 2(C), may be disposed only at the insulating tube (the outer surface or the inner surface or inside of the insulating tube) of the vertical lower point of the element (P2 in FIG. 2) corresponding to the middle point between the notched portion and the notched portion, so that the direction of arc energy is toward the side of the notched portion. In this way, the direction of the arc energy can be determined by the direction of the magnetic field of the same magnitude induced in each notched portion.

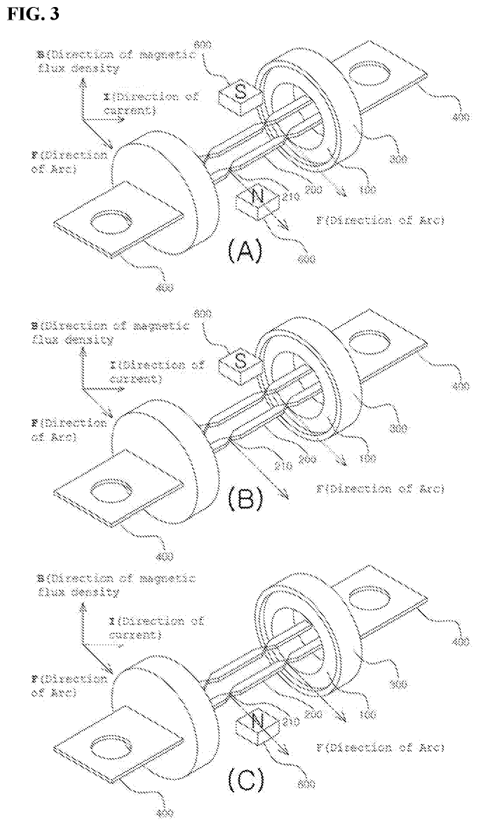

FIG. 2 (A), (B), (C) is shown that the magnet is disposed only on the outer surface of the insulating tube, but as described above, the magnet of the present invention according to the first embodiment, as shown in FIG. 14, is also disposed on the inner side or the inside of the insulating tube. The direction of the irregular arc energy generated when the element 200 is melted by the direction of magnetic field of the magnet arranged as shown in FIG. 2 proceeds in the lateral direction of the notched portion (direction F in FIG. 3) as shown in FIG. 3, which is a certain direction according to Fleming's left-hand rule. And, by the impact of the arc energy aggregated in one direction (the lateral direction of the notched portion (direction F in FIG. 3)), a rapid blocking (short circuit) of the notched portion 210 of the element 200 occurs.

Specifically, as shown in FIG. 2, when the magnet is disposed in the insulating tube, the direction of magnetic field of the magnet, the direction of current flowing through the element, and the direction of arc energy are as shown in FIG. 3 by Fleming's left-hand rule. FIG. 3 shows a direction of magnetic field of a magnet, a direction of current flowing through an element, and a direction of arc energy corresponding to the magnet arrangement as shown in FIG. 2.

In the conventional fuse without a magnet, since the progress direction of arc energy is a direction of irregular, a certain amount of time was required before the notched portion was cut (disconnected). However, in the present invention, the progress direction of arc energy is concentrated in a certain direction by the direction of magnetic field of the magnet, so that the time for the notching portion to be cut (disconnected) by the impact of the arc energy aggregated in one direction is faster than conventional. That is, a problem (an insulating tube breakage, a device breakage, etc.) occurs due to an arc generated during the time when the notched portion is cut (disconnected). Here, the time at which the notched portion is cut (disconnected) is a time from the start of melting of the notched portion to the point at which the blocking is completed, which means the time to block the fault current of the fuse link. Reducing the time that the notched portion is cut (disconnected), that is, reducing the time to block the fault current, provides an effect of minimizing problems caused by arcs (an insulating tube breakage, a device breakage, etc.). This part is the core technical idea of the present invention.

More specifically, as shown in FIG. 3, the direction of arc energy progressing by the direction of magnetic field of the magnet is a lateral direction of the notched portion 210 of the element (direction F in FIG. 3) according to Fleming's left-hand rule, and the element notched portion 210 is quickly cut (disconnected) by the impact of the arc energy condensed in one direction, thereby quickly blocking the fault current. As a result, by increasing the blocking speed of the fault current of the fuse link to reduce the blocking time, and by reducing the peak value of the blocking current according to the reduction of the blocking time, and by reducing the amount of arc energy generated, the impact caused by a high-speed blocking of fuse link and an arc energy after blocking is to be minimized. Through this, it is possible to reduce the product size compared to the conventional fuse link having the same rated voltage and current characteristics, and it is also possible to use a larger rated voltage and rated current than a fuse link of the same size.

In addition, as shown in FIG. 2, the reason that the magnet is disposed in the insulating tube at the positions (P1, P2) corresponding to the middle point between the notched portion 210 and the notched portion 210 is that the magnetic field intensity of the same size is induced in each of the notched portions so that the notched portions are simultaneously cut (disconnected).

If the magnet is disposed in a position that is biased toward the notching portion 210, the magnetic field intensity induced in the notching portion 210 close to the magnet is relatively greater than the magnetic field intensity induced in the notching portion 210 far from the magnet. As a result, the magnitude of the arc energy applied to the notched portion is also different, so that the cutting (disconnection) speed of the notched portions is different.

If the notched portions are block at different times, a problem occurs due to a recovery voltage. In order to solve the problem caused by the recovery voltage, the notched portions must be block at the same time. The problem caused by the recovery voltage means that a sufficient insulation distance is not secured despite the blocking of the notched portion, so that the fault current crosses the blocking notched portion and causes a secondary inflow of the fault current, so that the disconnecting function of the fuse link is not properly exercised. For example, the generation of a recovery voltage can be blocked only when a sufficient insulation distance is secured by blocking the element notched portion, thereby preventing the secondary inflow of a fault current. However, when the magnetic field intensity is largely introduced only to the notched portion at a specific point, simultaneous blocking of the notched portions is impossible. In this state (a state where only the notched portion at a specific point is cut first and the other notched portions are not cut), it is not possible to secure a sufficient insulation distance by only blocking the notched portion at the first cut point, and an electric current is formed with the previously cut notched portion, whereby a recovery voltage is generated. As a result, the fault current is introduced secondarily, causing the fuse link to explode or cause a fire, causing a fatal problem that cannot protect the circuit. Therefore, in order to prevent the problem of the recovery voltage from occurring, the notched portions must be cut at the same time to secure a sufficient insulating distance. To this end, a magnet is placed in a insulating tube at a position corresponding to a middle point between the notched portion 210 and the notched portion 210 so that the magnetic field intensity of the same size can be induced in each notched portion.

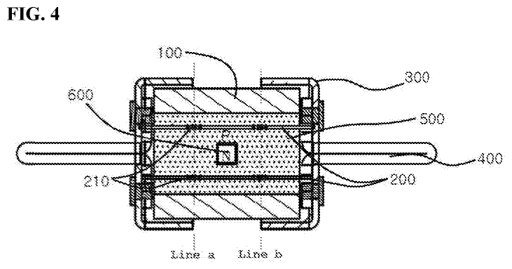

Next, according to the second embodiment of the magnet arrangement of the present invention shown in FIG. 4, the magnet 600, at least one magnet is a position (P1 in FIG. 4) corresponding to the middle point between the notched portion and the notched portion to induce the magnetic field intensity of the same size in each notched portion.

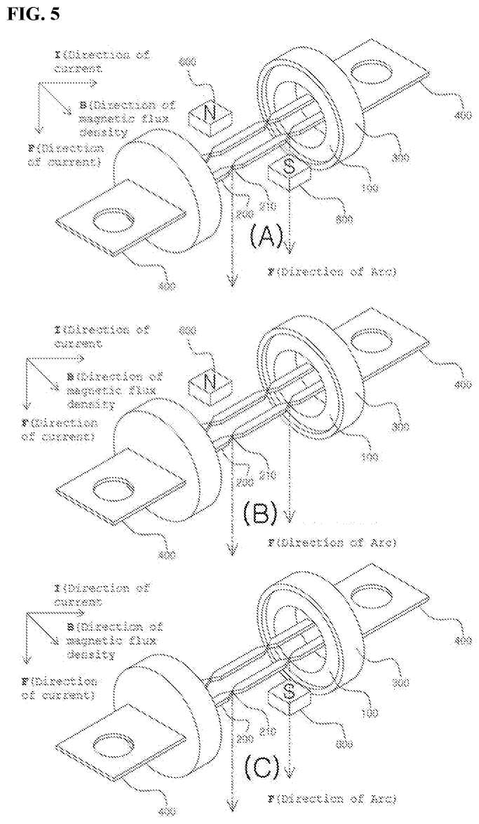

At least one or more magnet disposed in an insulating tube at a position (P1 in FIG. 4) corresponding to a middle point between the notched portion 210 and the notched portion 210, as shown in FIG. 5(A), may be disposed in both at the insulating tube (the outer surface or the inner surface or inside of the insulating tube) of one point horizontal in the lateral direction of the element corresponding to the middle point between the notched portion and the notched portion and at the insulating tube (the outer surface or the inner surface or inside of the insulating tube) of other point horizontal in the lateral direction of the element corresponding to the middle point between the notched portion and the notched portion, or as shown in FIG. 5(B), may be disposed only at the insulating tube (the outer surface or the inner surface or inside of the insulating tube) of one point horizontal in the lateral direction of the element corresponding to the middle point between the notched portion and the notched portion, or as shown in FIG. 5(C), may be disposed only at the insulating tube (the outer surface or the inner surface or inside of the insulating tube) of other point horizontal in the lateral direction of the element corresponding to the middle point between the notched portion and the notched portion, so that the direction of arc energy is toward the side of the notched portion. In this way, the direction of the arc energy can be determined by the direction of the magnetic field of the same magnitude induced in each notched portion.

FIG. 4 shows that the magnet is disposed only on the outer surface of the insulating tube at a point horizontal in the lateral direction of the element corresponding to the middle point between the notched portion and the notched portion, but as described above, the magnet of the present invention according to the second embodiment as shown in FIG. 14, it is characterized in that it is also disposed on the inner side or the inside of the insulating tube.

The direction of the irregular arc energy generated when the element 200 is melted by the direction of magnetic field of the magnet arranged as shown in FIG. 4 proceeds in the lateral direction of the notched portion (direction F in FIG. 5) as shown in FIG. 5, which is a certain direction according to Fleming's left-hand rule. And, by the impact of the arc energy aggregated in one direction (the vertical direction of the notched portion (direction F in FIG. 5)), a rapid blocking (short circuit) of the notched portion 210 of the element 200 occurs.

The second embodiment according to the magnet arrangement has only a difference in the position where the magnet is disposed compared to the first embodiment, and the effect and function are the same, so a detailed description will be omitted. That is, in the second embodiment, the position where the magnet is disposed is different from the first embodiment in which the magnet is disposed in the insulating tube at a point corresponding to a middle point between the notched portion and the notched portion. The position where the magnet is placed, as shown in FIG. 5, may be disposed in both at the insulating tube of one point horizontal in the lateral direction of the element corresponding to the middle point between the notched portion and the notched portion and at the insulating tube of other point horizontal in the lateral direction of the element corresponding to the middle point between the notched portion and the notched portion (see in FIG. 5(A)), or may be disposed only at the insulating tube of one point horizontal in the lateral direction of the element corresponding to the middle point between the notched portion and the notched portion (see in FIG. 5(B)), or may be disposed only at the insulating tube of other point horizontal in the lateral direction of the element corresponding to the middle point between the notched portion and the notched portion (see in FIG. 5(C)).

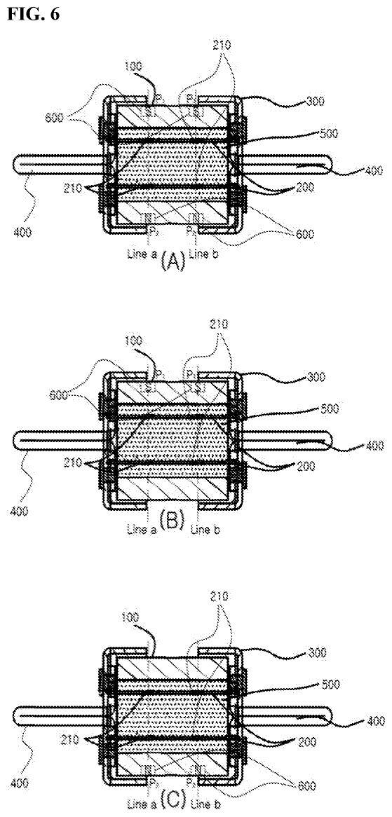

Next, according to the third embodiment of the magnet arrangement of the present invention shown in FIG. 6, in the magnet 600, at least two or more magnet is disposed in an insulating tube at a position (P1, P2 in FIG. 6) corresponding to the notched portion, so that the magnetic field intensity of the same size is induced in each notched portion.

At least two or more magnet disposed in an insulating tube at a position (P1, P2 in FIG. 6) corresponding to the notched portion, as shown in FIG. 6(A), may be disposed in both at the insulating tube (the outer surface or the inner surface or inside of the insulating tube) of the vertical upper point (P1 in FIG. 6) of the element corresponding to notched portion and the insulating tube (the outer surface or the inner surface or inside of the insulating tube) of the vertical lower point (P2 in FIG. 6) of the element corresponding to the notched portion, or as shown in FIG. 6(B), may be disposed only at the insulating tube (the outer surface or the inner surface or inside of the insulating tube) of the vertical upper point (P1 in FIG. 6) of the element corresponding to the notched portion, or as shown in FIG. 6(C), may be disposed only at the insulating tube (the outer surface or the inner surface or inside of the insulating tube) of the vertical lower point (P1 in FIG. 6) of the element corresponding to the notched portion, so that the direction of arc energy is toward the side of the notched portion. In this way, the direction of the arc energy can be determined by the direction of the magnetic field of the same magnitude induced in each notched portion.

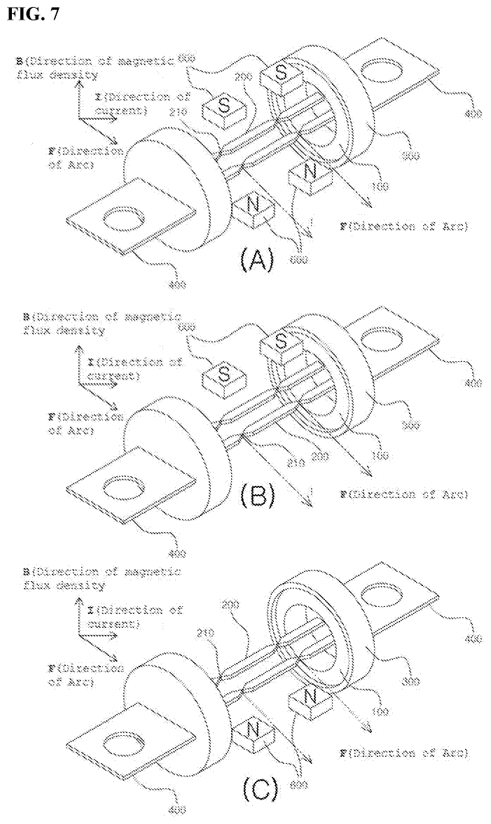

FIG. 6 (A), (B), (C) is shown that the magnet is disposed only on the outer surface of the insulating tube, but as described above, the magnet of the present invention according to the third embodiment, as shown in FIG. 14, is also disposed on the inner side or the inside of the insulating tube. The direction of the irregular arc energy generated when the element 200 is melted by the direction of magnetic field of the magnet arranged as shown in FIG. 6 proceeds in the lateral direction of the notched portion (direction F in FIG. 7) as shown in FIG. 7, which is a certain direction according to Fleming's left-hand rule. And, by the impact of the arc energy aggregated in one direction (the lateral direction of the notched portion (direction F in FIG. 7)), a rapid blocking (short circuit) of the notched portion 210 of the element 200 occurs.

The third embodiment according to the magnet arrangement has only a difference in the position where the magnet is disposed compared to the first embodiment, and the effect and function are the same, so a detailed description will be omitted. That is, in the third embodiment, the position where the magnet is disposed is different from the first embodiment in which the magnet is disposed in the insulating tube at a point corresponding to a middle point between the notched portion and the notched portion. The position where the magnet is placed, as shown in FIG. 6, may be disposed in both at the insulating tube of the vertical upper point (P1 in FIG. 6) corresponding to the notched portion and at the insulating tube of the vertical lower point (P2 in FIG. 6) corresponding to the notched portion (see in FIG. 6(A)), or may be disposed only at the insulating tube of the vertical upper point (P1 in FIG. 6) corresponding to the notched portion (see in FIG. 6(B)), or may be disposed only at the insulating tube of the vertical lower point (P2 in FIG. 6) corresponding to the notched portion (see in FIG. 6(C)).

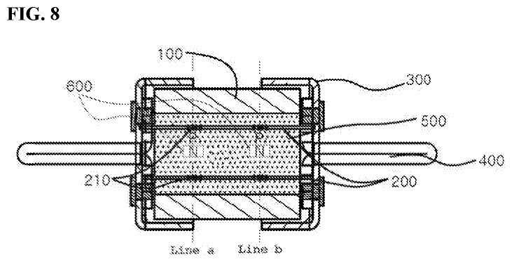

Next, according to the fourth embodiment of the magnet arrangement of the present invention shown in FIG. 8, in the magnet 600, at least two or more magnet is disposed in an insulating tube at a position (P1 in FIG. 8) corresponding to the notched portion, so that the magnetic field intensity of the same size is induced in each notched portion.

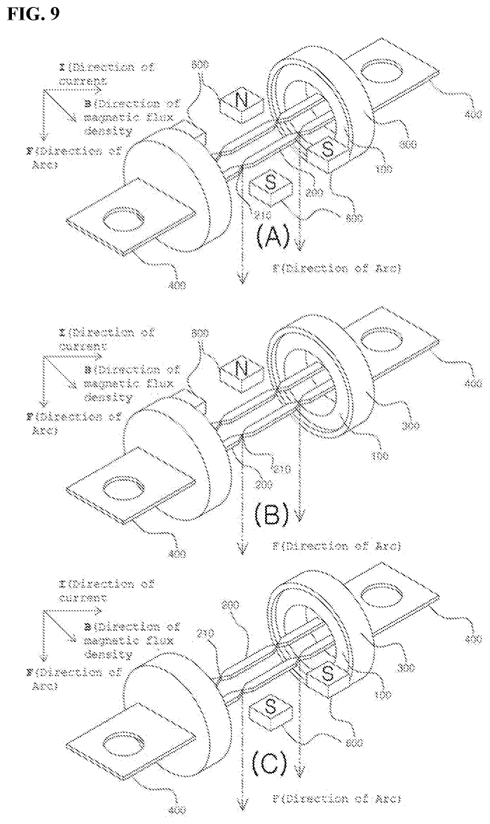

At least two or more magnet disposed in an insulating tube at a position corresponding to the notched portion, as shown in FIG. 9(A), may be disposed in both at the insulating tube (the outer surface or the inner surface or inside of the insulating tube) of one horizontal point in the lateral direction of the element corresponding to notched portion and the insulating tube (the outer surface or the inner surface or inside of the insulating tube) of other horizontal point in the lateral direction of the element corresponding to the notched portion, or as shown in FIG. 9(B), may be disposed only at the insulating tube (the outer surface or the inner surface or inside of the insulating tube) of one horizontal point in the lateral direction of the element corresponding to the notched portion, or as shown in FIG. 9(C), may be disposed only at the insulating tube (the outer surface or the inner surface or inside of the insulating tube) of other horizontal point in the lateral direction of the element corresponding to the notched portion, so that the progress direction of arc energy is toward the vertical direction of the notched portion. In this way, the direction of the arc energy can be determined by the direction of the magnetic field of the same magnitude induced in each notched portion.

FIG. 8 is shown that the magnet is disposed only on the outer surface of the insulating tube of the horizontal point in the lateral direction of the element corresponding to the notched portion, but as described above, the magnet of the present invention according to the fourth embodiment, as shown in FIG. 14, is also disposed on the inner side or the inside of the insulating tube. The direction of the irregular arc energy generated when the element 200 is melted by the direction of magnetic field of the magnet arranged as shown in FIG. 8 proceeds in the vertical direction of the notched portion (direction F in FIG. 9) as shown in FIG. 9, which is a certain direction according to Fleming's left-hand rule. And, by the impact of the arc energy aggregated in one direction (the vertical direction of the notched portion (direction F in FIG. 9)), a rapid blocking (short circuit) of the notched portion 210 of the element 200 occurs.

The fourth embodiment according to the magnet arrangement has only a difference in the position where the magnet is disposed compared to the first embodiment, and the effect and function are the same, so a detailed description will be omitted. That is, in the fourth embodiment, the position where the magnet is disposed is different from the first embodiment in which the magnet is disposed in the insulating tube at a point corresponding to a middle point between the notched portion and the notched portion. The position where the magnet is placed, as shown in FIG. 9, may be disposed in both at the insulating tube of one horizontal point corresponding to the notched portion and at the insulating tube of other horizontal point corresponding to the notched portion (see in FIG. 9(A)), or may be disposed only at the insulating tube of one horizontal point corresponding to the notched portion (see in FIG. 9(B)), or may be disposed only at the insulating tube of other horizontal point corresponding to the notched portion (see in FIG. 9(C)).

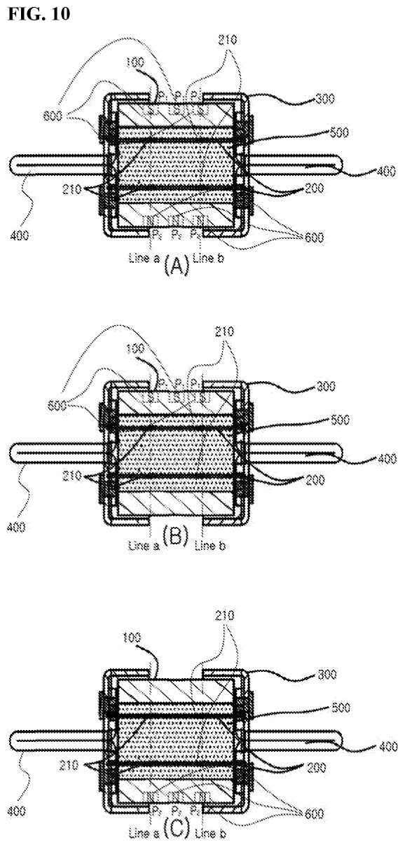

Next, according to the fifth embodiment of the magnet arrangement of the present invention shown in FIG. 10, in the magnet 600, at least three or more magnet is disposed in an insulating tube at a position (P1, P2 in FIG. 10) corresponding to the notched portion, so that the magnetic field intensity of the same size is induced in each notched portion.

At least three or more magnet disposed in an insulating tube at a position (P1 in FIG. 10) corresponding to a middle point between the notched portion and the notched portion and a point of the notched portion, as shown in FIG. 10(A), may be disposed in both at the insulating tube (the outer surface or the inner surface or inside of the insulating tube) of vertical upper point of the element corresponding to the middle point between the notched portion and the notched portion, and the notched portion and at the insulating tube (the outer surface or the inner surface or inside of the insulating tube) of vertical lower point of the element corresponding to the middle point between the notched portion and the notched portion and a point of the notched portion, or as shown in FIG. 10(B), may be disposed only at the insulating tube (the outer surface or the inner surface or inside of the insulating tube) of the vertical upper point of the element corresponding to the middle point between the notched portion and the notched portion and a point of the notched portion, or as shown in FIG. 10(C), may be disposed only at the insulating tube (the outer surface or the inner surface or inside of the insulating tube) of vertical lower point of the element corresponding to the middle point between the notched portion and the notched portion and a point of the notched portion, so that the direction of arc energy is toward the side of the notched portion. In this way, the direction of the arc energy can be determined by the direction of the magnetic field of the same magnitude induced in each notched portion.

FIG. 10(A), 10(B), 10(C) shows that the magnet is disposed only on the outer surface of the insulating tube, but as described above, the magnet of the present invention according to the fifth embodiment as shown in FIG. 14, it is characterized in that it is also disposed on the inner side or the inside of the insulating tube.

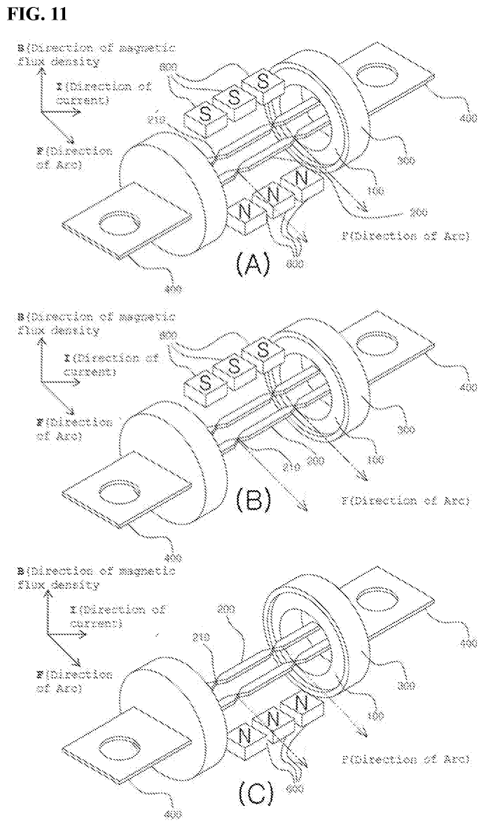

The direction of the irregular arc energy generated when the element 200 is melted by the direction of magnetic field of the magnet arranged as shown in FIG. 10 proceeds in the lateral direction of the notched portion (direction F in FIG. 11) as shown in FIG. 11, which is a certain direction according to Fleming's left-hand rule. And, by the impact of the arc energy aggregated in one direction (the lateral direction of the notched portion (direction F in FIG. 11)), a rapid blocking (short circuit) of the notched portion 210 of the element 200 occurs.

The fifth embodiment according to the magnet arrangement has only a difference in the position where the magnet is disposed compared to the first embodiment, and the effect and function are the same, so a detailed description will be omitted. That is, in the fifth embodiment, the position where the magnet is disposed is different from the first embodiment in which the magnet is disposed in the insulating tube at a point corresponding to a middle point between the notched portion and the notched portion. The position where the magnet is placed, as shown in FIG. 10, may be disposed in both at the insulating tube of the vertical upper point (P1 in FIG. 10) of the element corresponding to a point of the notched portion and the middle point between the notched portion and the notched portion and at the insulating tube of the vertical lower point (P2 in FIG. 10) of the element corresponding to a point of the notched portion and the middle point between the notched portion and the notched portion (see in FIG. 10(A)), or may be disposed only at the insulating tube of the vertical point of the element corresponding to a point of the notched portion and the middle point between the notched portion and the notched portion (see in FIG. 10(B)), or may be disposed only at the insulating tube of the vertical lower point of the element corresponding to a point of the notched portion and the middle point between the notched portion and the notched portion (see in FIG. 10(C)).

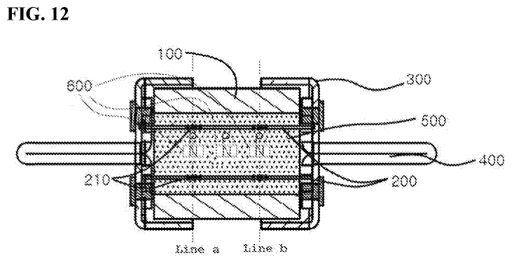

Next, according to the sixth embodiment of the magnet arrangement of the present invention shown in FIG. 12, in the magnet 600, at least three or more magnet is disposed in an insulating tube at a position (P1 in FIG. 12) corresponding to the notched portion, so that the magnetic field intensity of the same size is induced in each notched portion.

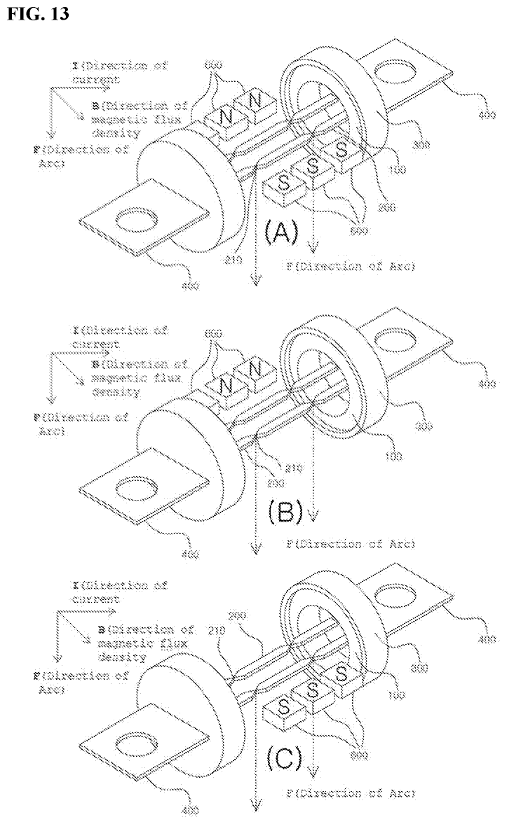

At least three or more magnet disposed in an insulating tube at a position (P1 in FIG. 12) corresponding to a point of the notched portion and a middle point between the notched portion and the notched portion, as shown in FIG. 13(A), may be disposed in both at the insulating tube (the outer surface or the inner surface or inside of the insulating tube) of one horizontal point in the lateral direction of the element corresponding to a point of the notched portion and the middle point between the notched portion and the notched portion and at the insulating tube (the outer surface or the inner surface or inside of the insulating tube) of other horizontal point in the lateral direction of the element corresponding to a point of the notched portion and the middle point between the notched portion and the notched portion, or as shown in FIG. 13(B), may be disposed only at the insulating tube (the outer surface or the inner surface or inside of the insulating tube) of one horizontal point in the lateral direction of the element corresponding to a point of the notched portion and the middle point between the notched portion and the notched portion, or as shown in FIG. 13(C), may be disposed only at the insulating tube (the outer surface or the inner surface or inside of the insulating tube) of other horizontal point in the lateral direction of the element corresponding to a point of the notched portion the middle point between the notched portion and the notched portion, so that the direction of arc energy is toward the vertical direction of the notched portion. In this way, the direction of the arc energy can be determined by the direction of the magnetic field of the same magnitude induced in each notched portion.

In FIG. 12, it is shown that the magnet is disposed only on the outer surface of the insulating tube at a horizontal point in the lateral direction of the element corresponding to the notched portion and the middle point between the notched portion and the notched portion, but as described above, the magnet of the present invention according to the fifth embodiment as shown in FIG. 14, it is characterized in that it is also disposed on the inner side or the inside of the insulating tube.

The direction of the irregular arc energy generated when the element 200 is melted by the direction of magnetic field of the magnet arranged as shown in FIG. 12 proceeds in the vertical direction of the notched portion (direction F in FIG. 13) as shown in FIG. 13, which is a certain direction according to Fleming's left-hand rule. And, by the impact of the arc energy aggregated in one direction (the vertical direction of the notched portion (direction F in FIG. 13)), a rapid blocking (short circuit) of the notched portion 210 of the element 200 occurs.

The sixth embodiment according to the magnet arrangement has only a difference in the position where the magnet is disposed compared to the first embodiment, and the effect and function are the same, so a detailed description will be omitted. That is, in the sixth embodiment, the position where the magnet is disposed is different from the first embodiment in which the magnet is disposed in the insulating tube at a point corresponding to a middle point between the notched portion and the notched portion. The position where the magnet is placed, as shown in FIG. 13, may be disposed in both at the insulating tube of one horizontal point in the lateral direction of the element corresponding to a point of the notched portion and the middle point between the notched portion and the notched portion and at the insulating tube of other horizontal point in the lateral direction of the element corresponding to a point of the notched portion and the middle point between the notched portion and the notched portion (see in FIG. 13(A)), or may be disposed only at the insulating tube of one horizontal point in the lateral direction of the element corresponding to a point of the notched portion and the middle point between the notched portion and the notched portion (see in FIG. 13(B)), or may be disposed only at the insulating tube of other horizontal point in the lateral direction of the element corresponding to a point of the notched portion and the middle point between the notched portion and the notched portion (see in FIG. 13(C)).

In addition, the present invention can be further comprises, as shown in FIG. 2, 4, 6, 8, 10, 12, the cap 300 surrounding a part of both sides of the outer surface of the insulating tube 100 or the entire outer surface (not shown) of the insulating tube 100.

The cap 300 configured as described above has a function to protect the insulating tube and is connected to the element 200 so that an external current can flow through the element 200. In this case, a terminal may be configured to allow external current to be drawn in and out on one side of the cap 300.

In addition, the shape of the cap 300 is formed according to the shape of the insulating tube 100, and can be applied regardless of the shape of a cylinder, a rectangular parallelepiped, or a regular cube.

In addition, the present invention may be configured to further include a power connector 400 formed in the cap 300 surrounding a part of both sides of the outer surface of the insulating tube 100 or the entire outer surface (not shown) of the insulating tube 100 as shown in FIGS. 2, 4, 6, 8, 10, 12.

In this case, the power connector 400 is connected to the element 200 so that an external current flows through the element 200.

In addition, the present invention may further include a silica sand layer 500 filled in the inner space of the insulating tube 100 as shown in FIGS. 2, 4, 6, 8, 10, 12.

In order to minimize the influence of the arc generated when the fault current is introduced, the silica sand constituting the silica sand layer 500 is adsorbed to the element or the wall of the insulating tube by an arc voltage generated when the notched portion 210 of the element 200 is melted by the fault current. Accordingly, insulation is provided to the element 200 or the insulation performance of the entire fuse link is increased. By doing this, it serves to prevent the secondary flow of the fault current generated by the recovery voltage generated after the fault current is blocked.

The ordinary skilled person in the art to which the present invention with the above contents pertains will be able to understand that the present invention can be implemented in other specific forms without changing the technical spirit or essential features of the present invention. Therefore, the embodiments described above are exemplified in all respects and should be understood as non-limiting.

1. A fuse link comprising a permanent magnet for inducing arc directivity, the fuse link comprising:
an insulating tube (100) in the form of housing that is an insulating material and has space inside;
an element (200) formed in the inner space of the insulating tube (100) and having at least one notched portion (210) formed therein; and
at least one or more magnet (600) formed in the insulating tube (100) so as to provide the progress direction of arc energy to the arc generated in the notched portion when the notched portion (210) of the element (200) is melted by a fault current by inducing a magnetic field intensity located in the notching portion of element (200),
wherein the magnet (600) is formed into outer surface of the insulating tube (100), or formed into the inner surface of the insulating tube (100), or inserted into inside space of the insulating tube (100), and at least one or more element (200) is formed in the inner space of the insulating tube (100).

2. The fuse link of claim 1, wherein the magnet (600) is disposed in the outer surface of the insulating tube (100) or the inner surface of the insulating tube (100) or the inside of the insulating tube (100).

3. The fuse link of claim 1, wherein the magnet (600) is a permanent magnet having a polarity of N or S pole forming a magnetic field orthogonal to the direction of the current flowing through the element (200), or a magnetic substance equivalent thereto.

4. The fuse link of claim 1, wherein when two or more elements (200) are formed, the positions of the respective notched portions (210) formed on each element (200) are formed to be located on the same line as the respective notched portions (210) formed on the other elements (200).

5. The fuse link of claim 2, wherein the magnet (600) includes at least one or more magnets disposed in an insulating tube at a position corresponding to a middle point between the notched portion and the notched portion,
wherein at least one or more magnets induce a magnetic field intensity in each notched portion, and may be disposed in both at the insulating tube of a vertical upper point of the element corresponding to the middle point between the notched portion and the notched portion and the insulating tube of a vertical lower point of the element corresponding to the middle point between the notched portion and the notched portion, or may be disposed only at the insulating tube of the vertical upper point of the element corresponding to the middle point between the notched portion and the notched portion, or may be disposed only at the insulating tube of the vertical lower point of the element corresponding to the middle point between the notched portion and the notched portion, so that the direction of arc energy is toward the side direction of the notched portion,
wherein the direction of the arc energy is determined by the direction of the magnetic field of the same magnitude induced in each notched portion.

6. The fuse link of claim 2, wherein the magnet (600) includes at least one or more magnets disposed in an insulating tube at a position corresponding to a middle point between the notched portion and the notched portion,
wherein at least one or more magnets induce a magnetic field intensity in each notched portion, and may be disposed in both at the insulating tube of one point horizontally in the lateral direction of the element corresponding to the middle point between the notched portion and the notched portion and the insulating tube of other point horizontally in the lateral direction of the element corresponding to the middle point between the notched portion and the notched portion, or may be disposed only at the insulating tube of the one point horizontally in the lateral direction of the element corresponding to the middle point between the notched portion and the notched portion, or may be disposed only at the insulating tube of the other point horizontally in the lateral direction of the element corresponding to the middle point between the notched portion and the notched portion, so that the direction of arc energy is toward a vertical direction of the notched portion,
wherein the direction of the arc energy is determined by the direction of the magnetic field of the same magnitude induced in each notched portion.

7. The fuse link of claim 2, wherein the magnet (600) includes at least two or more magnets disposed in an insulating tube at a position corresponding to a point of the notched portion,
wherein at least two or more magnets induce a magnetic field intensity of the same size in each notched portion, and may be disposed in both at the insulating tube of a vertical upper point of the element corresponding to the point of the notched portion and at the insulating tube of a vertical lower point of the element corresponding to the point of the notched portion, or may be disposed only at the insulating tube of a vertical upper point of the element corresponding to the point of the notched portion, or may be disposed only at the insulating tube of a vertical lower point of the element corresponding to the point of the notched portion, so that the direction of arc energy is toward a side direction of the notched portion,
wherein the direction of the arc energy is determined by the direction of the magnetic field of the same magnitude induced in each notched portion.

8. The fuse link of claim 2, wherein the magnet (600) includes at least two or more magnets disposed in an insulating tube at a position corresponding to a point of the notched portion,
wherein at least two or more magnets induce a magnetic field intensity of the same size in each notched portion, and may be disposed in both at the insulating tube of one point horizontally in the lateral direction of the element corresponding to a point of the notched portion and at the insulating tube of other point horizontally in the lateral direction of the element corresponding to the point of the notched portion, or may be disposed only at the insulating tube of the one point horizontally in the lateral direction of the element corresponding to the point of the notched portion, or may be disposed only at the insulating tube of the other point horizontally in the lateral direction of the element corresponding to the point of the notched portion, so that the direction of arc energy is toward a vertical direction of the notched portion,
wherein the direction of the arc energy is determined by the direction of the magnetic field of the same magnitude induced in each notched portion.

9. The fuse link of claim 2, wherein the magnet (600) includes at least three or more magnets disposed in an insulating tube at a position corresponding to a middle point between the notched portion and the notched portion,
wherein at least three or more magnets induce a magnetic field intensity of the same size in each notched portion, and may be disposed in both at the insulating tube of a vertical upper point of the element corresponding to the notched portion and the middle point between the notched portion and the notched portion and at the insulating tube of a vertical lower point of the element corresponding to the notched portion and the middle point between the notched portion and the notched portion, or may be disposed only at the insulating tube of the vertical upper point of the element corresponding to the notched portion and the middle point between the notched portion and the notched portion, or may be disposed only at the insulating tube of the vertical lower point of the element corresponding to the notched portion and the middle point between the notched portion and the notched portion, so that the direction of arc energy is toward a side direction of the notched portion,
wherein the direction of arc energy is determined by the direction of the magnetic field of the same magnitude induced in each notched portion.

10. The fuse link of claim 2, wherein the magnet (600) includes at least three or more magnets disposed in an insulating tube at a position corresponding to a middle point between the notched portion and the notched portion,
wherein at least three or more magnets induce a magnetic field intensity of the same size in each notched portion, and may be disposed in both at the insulating tube of one point horizontally in the lateral direction of the element corresponding to the notched portion and the middle point between the notched portion and the notched portion and at the insulating tube of other point horizontally in the lateral direction of the element corresponding to the notched portion and the middle point between the notched portion and the notched portion, or may be disposed only at the insulating tube of the one point horizontally in the lateral direction of the element corresponding to the notched portion and the middle point between the notched portion and the notched portion, or may be disposed only at the insulating tube of the other point horizontally in the lateral direction of the element corresponding to the notched portion and the middle point between the notched portion and the notched portion, so that the direction of arc energy is toward a vertical direction of the notched portion,
wherein the direction of arc energy is determined by the direction of the magnetic field of the same magnitude induced in each notched portion.

11. The fuse link of claim 2, wherein when the magnet (600) is disposed on the outer side of the insulating tube (100), the magnet (600) disposed on the outer side of the insulating tube (100) and the outer side of the insulating tube (100) are coated with an insulating material so that the outer surface is coated with an insulating material to prevent the magnet from acting as a conductor.

12. The fuse link of claim 1, further comprising a cap (300) surrounding a part of both sides of the outer surface of the insulating tube (100) or the entire outer surface of the insulating tube (100), wherein the cap (300) is connected to the element (200) to allow an external current to flow through the element (200).

13. The fuse link of claim 12, further comprising a power connection unit (400) formed on the cap (300), wherein the power connection unit (400) is connected to the element (200) to allow external current to flow through the element (200).

14. The fuse link of claim 1, further comprising a silica sand layer (500) filled in the inner space of the insulating tube (100), wherein the silica sand layer (500) is adsorbed to the element (200) by the arc voltage generated when the notched portion (210) of the element (200) is melted by a fault current to provide insulation to the element (200).

15. The fuse link of claim 1, wherein the shape of the element (200) is a straight line, a triangular wave shape for extending the length of the element (200), a pulse wave shape, or a combination of a triangle wave shape and a pulse wave shape.
